(19) United States
(12) Patent Application Publication
(10) Pub. No.: US 2019/0284094 A1
(43) Pub. Date: Sep. 19, 2019

(54) ELECTRICALLY CONDUCTIVE CEMENT-BASED COMPOSITE COMPOSITION

(71) Applicant: KOREA ADVANCED INSTITUTE OF SCIENCE AND TECHNOLOGY, Daejeon (KR)

(72) Inventors: Haengki LEE, Daejeon (KR); Gwangmok KIM, Daejeon (KR); Solmoi PARK, Daejeon (KR)

(73) Assignee: KOREA ADVANCED INSTITUTE OF SCIENCE AND TECHNOLOGY, Daejeon (KR)

(21) Appl. No.: 16/465,049

(22) PCT Filed: Mar. 15, 2017
(86) PCT No.: PCT/KR2017/002797

§ 371 Date: May 29, 2019

(30) Foreign Application Priority Data
Dec. 1, 2016 (KR) 10-2016-0162738

(51) Int. Cl. C04B 14/02; C04B 14/38; C04B 18/14

(52) U.S. Cl. CPC C04B 14/026; C04B 2103/32; C04B 18/146; C04B 14/386

(57) ABSTRACT

Disclosed is an electrically conductive cement-based composite composition capable of exhibiting stable electrical performance since carbon nanotubes and carbon fibers are mixed in cement at a proper weight ratio so as to lower sensitivity to a specific resistance change caused by the change in a water/cement ratio (w/c). The electrically conductive cement-based composite composition includes, in order to have stable electrical characteristics of which a specific resistance is 100 Ω·cm or less even with the change in the water/cement ratio (w/c), the cement, 0.1-0.5 wt % of the carbon nanotubes on the basis of the cement weight, 0.1-0.4 wt % of the carbon fibers on the basis of the cement weight, and silica fume and a superplasticizer as other additives.

### CROSS-REFERENCE TO PRIOR APPLICATIONS

This application is a National Stage Patent Application of PCT International Patent Application No. PCT/KR2017/002797 (filed on Mar. 15, 2017) under 35 U.S.C. § 371, which claims priority to Korean Patent Application No. 10-2016-0162738 (filed on Dec. 1, 2016), which are all hereby incorporated by reference in their entirety.

### BACKGROUND

The present invention relates to an electrically conductive cement-based composite material, and more particularly, to an electrically conductive cement-based composite composition capable of exhibiting stable electrical performance by reducing sensitivity to the change in electrical resistivity according to the change in water/cement ratio (w/c) by mixing carbon nanotubes and carbon fibers with cement at proper weight ratios.

A conductive cement-based material is an electrically conductive cement-based material, and may be used to reduce a grounding resistance, prevent static electricity, and used in a piezoresistive sensor, an electromagnetic wave-shielding material or a heating element product.

Generally, as a method of preparing a conductive cement-based material, a method using a conventional conductive filler such as steel fiber or graphite or a method of using a nano material such as carbon nanotubes (CNTs) are used.

A conductive cement-based material prepared using steel fiber has disadvantages of degradation of electrical performance of the cement-based composite due to corrosion of the steel fiber, damage to the steel fiber due to exposure, relatively low electrical conductivity of the composite, and a great change in electrical conductivity due to temperature.

In addition, in the case of a cement-based composite prepared using graphite, 15% or more of graphite should be mixed to ensure electrical conductivity. Therefore, the mechanical performance of the composite may be drastically degraded, and there is a problem in that it is not possible to prepare the cement-based composite by simple curing and thus extrusion molding is required.

While a cement composite prepared using CNTs may not have problems that can occur in the above-described cement-based composites mixed with steel fiber and graphite, to ensure high electrical conductivity, the cement composite should be poured with a very limited water/cement ratio (w/c) (weight ratio of a water content to a cement content, which are mixed in a concrete or cement paste), otherwise, electrical conductivity may be easily changed by temperature and moisture.

In other words, the cement-based composite prepared using carbon nanotubes (CNT) has superior electrical conductivity and mechanical properties, but due to nano-sized CNTs, there is a disadvantage of a rapid change in electrical property, caused by a water/cement ratio (w/c) used in the preparation.

This becomes a technical limitation to commercialization of the CNT-mixed conductive cement-based composite. Therefore, it is necessary to develop a conductive composite which has excellent electrical conductivity and almost no change in electrical characteristic by the amount of water used in the preparation.

### SUMMARY

To solve the above-described problems, the present invention is directed to providing an electrically conductive cement-based composite composition which is capable of exhibiting stable electrical performance due to having excellent electrical conductivity and almost no change in electrical characteristic resulting from a water/cement ratio (w/c) used in preparation.

To attain the object of the present invention, an electrically conductive cement-based composite composition according to the present invention may include cement, carbon nanotubes, and 0.1 to 0.4 wt % of carbon fibers with respect to the cement weight.

According to an exemplary embodiment of the present invention, the carbon fibers may be included at 0.1 to 0.2 wt % with respect to the cement weight.

In addition, the carbon nanotubes may be included at 0.1 to 0.5 wt % with respect to the cement weight.

According to another exemplary embodiment of the present invention, the electrically conductive cement-based composite composition may further include silica fume and a superplasticizer.

According to the present invention, a cement composite which has excellent electrical performance and a uniform quality can be prepared by mixing a nano material, carbon nanotubes (CNTs), and a micro material, carbon fibers, as conductive fillers with a cement material, and limiting the mixing ratio of carbon fibers to 0.1 to 0.4 wt % and the mixing amount of CNTs to 0.1 to 0.5 wt % with respect to the cement weight.

### BRIEF DESCRIPTION OF THE DRAWINGS

FIG. 1 is a diagram illustrating an action mechanism of an electrically conductive cement-based composite molded by mixing water with an electrically conductive cement-based composite composition according to the present invention.

FIG. 2 is a table showing examples of specimens prepared with different mixing amounts of carbon fibers while the mixing amount of CNTs mixed in cement is fixed.

FIG. 3 is a set of graphs showing the electrical resistivity and flow test results for cement compositions prepared using the specimens shown in FIG. 2, respectively.

FIG. 4 is a graph showing the flow test result for cement composite composition specimens prepared with different mixing amounts of carbon fibers.

FIG. 5 is a table showing examples of cement composite composition specimens prepared with different mixing amounts of carbon fibers and CNTs, which are mixed with cement.

FIG. 6 is a table showing the electrical resistivity and flow test results for cement composites prepared using the specimens shown in FIG. 5.

### DETAILED DESCRIPTION

Hereinafter, an electrically conductive cement-based composite composition according to the present invention will be described in detail with reference to the accompanying drawings.

The electrically conductive cement-based composite composition of the present invention consists of a mixture of cement, CNTs, carbon fibers and other additives, and is prepared by mixing the above-described mixture with water and molding the resulting mixture.

More specifically, to have a stable electrical characteristic, for example, an electrical resistivity of 100 Ω·cm or less, despite the change in water/cement ratio (w/c), the electrically conductive cement-based composite composition of the present invention may consist of cement, 0.1 to 0.5 wt % of nanotubes with respect to the cement weight, 0.1 to 0.4 wt % of carbon fibers with respect to the cement weight, and silica fume and a superplasticizer as other additives.

The CNTs, which are tubular nano-scale small particles, are used in various fields due to their unique structural, chemical, mechanical and electrical properties caused by strong sp² chemical bonding. While various types of the carbon nanotubes may be used, multi-wall carbon nanotubes having various lengths are preferably used.

As described above, since the electrically conductive cement-based composite composition of the present invention uses a nano material, i.e., CNTs and a micro material, i.e., carbon fibers as conductive fillers, which are mixed in the above-mentioned predetermined ratios (weight ratios), when an electrically conductive cement-based composite is prepared by being mixed with water, the composition has a stable electrical characteristic, such as an electrical resistivity of 100 Ω·cm or less, even with the change in water/cement ratio (w/c), high flow and excellent workability.

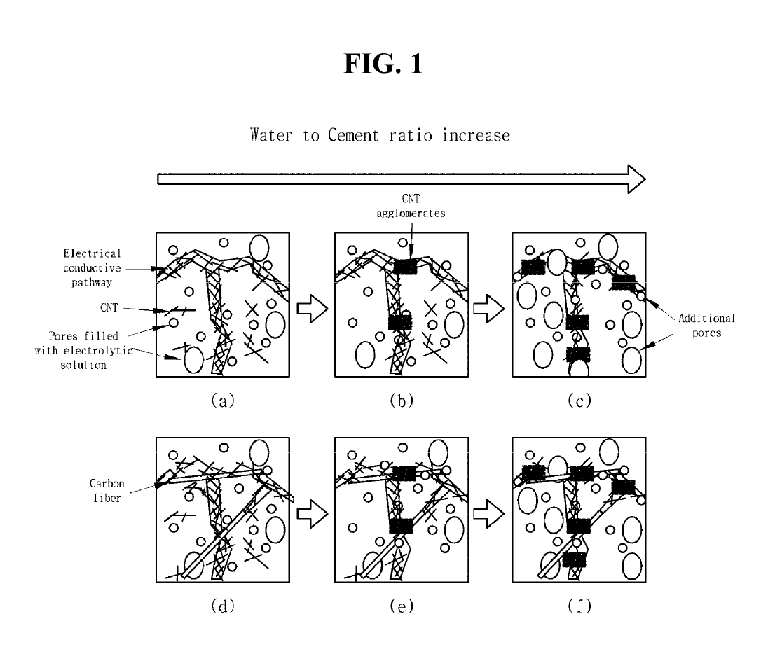

FIG. 1 is a diagram illustrating an action mechanism of an electrically conductive cement-based composite molded by mixing water with an electrically conductive cement-based composite composition according to the present invention, and as shown in FIGS. 1(a), (b) and (c), when only CNTs are mixed with a cement material without carbon fibers, as the water/cement ratio (w/c) increases, the agglomeration of CNTs increases, and pores filled with an electrolytic solution increase, showing an instable conductive network.

On the other hand, as shown in FIGS. 1(d), (e) and (f), when carbon fibers are mixed with CNTs in a cement material, as the water/cement ratio (w/c) increases, the agglomeration of the CNTs increases, and even though pores filled with an electrolytic solution increase, the carbon nanotubes are electrically connected by the carbon fibers, showing that the change in electrical conductivity may be prevented.

As the carbon fibers have to be mixed at as much as a predetermined weight ratio with respect to the cement, it may prevent an increase in electrical resistivity according to the change in water/cement ratio (w/c) and maintain flow at a desired level. A preferable mixing ratio of the carbon fibers to the cement in the present invention may be 0.1 to 0.4 wt % with respect to the cement weight, and more preferably, the carbon fibers are included at 0.1 to 0.2 wt % with respect to the cement weight.

When the carbon fibers are mixed at less than 0.1 wt % with respect to the cement weight, as the water/cement ratio (w/c) increases, the electrical resistivity drastically increases, and when the carbon fibers are mixed at more than 0.4 wt %, even though the water/cement ratio (w/c) increases, there is a problem of poor workability due to low flow.

The CNTs are preferable included at 0.1 to 0.5 wt % with respect to the cement weight. When the mixing amount of the carbon nanotubes is less than 0.1 wt %, since the electrical resistivity is rapidly increased, and the electrical conductivity is very low, the CNTs do not serve as a conductor, and when the mixing amount of the carbon nanotubes is more than 0.5 wt %, there is a problem of low workability due to a rapidly lowered flow.

Therefore, the mixing amount of the carbon fibers for ensuring excellent electrical conductivity and good workability is 0.1 to 0.4 wt % with respect to the cement weight, and the mixing amount of the CNTs is limited to 0.1 to 0.5 wt % with respect to the cement weight.

The silica fume inhibits the agglomeration of the carbon nanotubes and improves dispersity, thereby improving electrical conductivity.

### Example

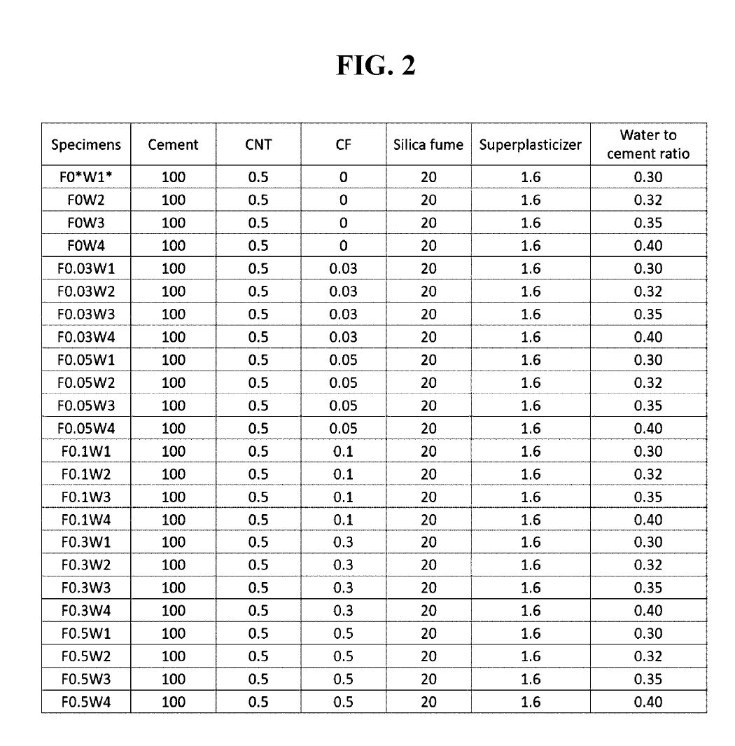

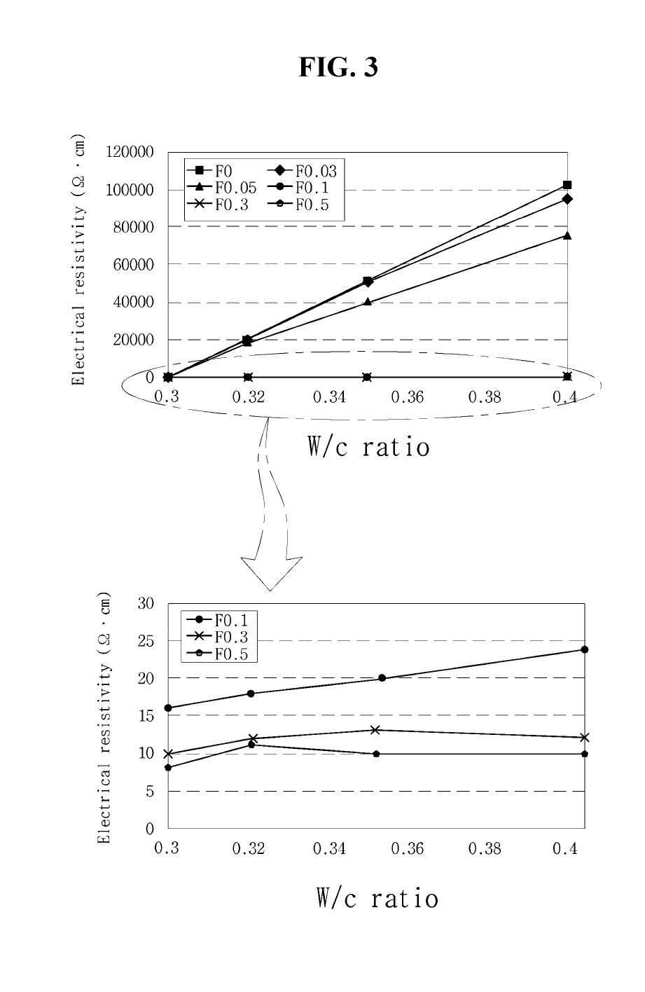

FIG. 2 is a table showing the cement composite specimens by fixing the mixing ratio of CNTs with respect to the cement weight to 0.5 wt %, changing the mixing ratio of the carbon fibers (CF) to 0 to 0.5 wt % with respect to the cement weight, and mixing silica fume and a superplasticizer, and FIG. 3 is a set of graphs showing the change in electrical resistivity with respect to the cement composite prepared through air dry curing after pouring each of the cement composite specimens shown in FIG. 2 into a cubic mold.

In FIG. 2, F, among characters representing the name of a specimen, means carbon fibers, and for example, F0.03 means that carbon fibers are mixed at 0.03 wt % with respect to the cement weight. In addition, W1, W2, W3 and W4 means that the water/cement ratios (w/c) are 0.3, 0.32, 0.35 and 0.40, respectively.

As shown in FIG. 3, when the carbon fibers are contained at 0.05 wt % or less (F0, F0.03 or F0.05), as the water/cement ratio (w/c) increases, the electrical resistivity rapidly increases, and when the carbon fibers are contained at 0.1 to 0.5 wt %, although the water/cement ratio (w/c) increases, it can be seen that the electrical resistivity is generally maintained constant to 100 Ω·cm or less.

Therefore, when the mixing amount of the carbon fibers is 0.1 to 0.5 wt % with respect to the cement weight, it can be seen that, despite the change in water/cement ratio (w/c), a stable electrical characteristic is exhibited.

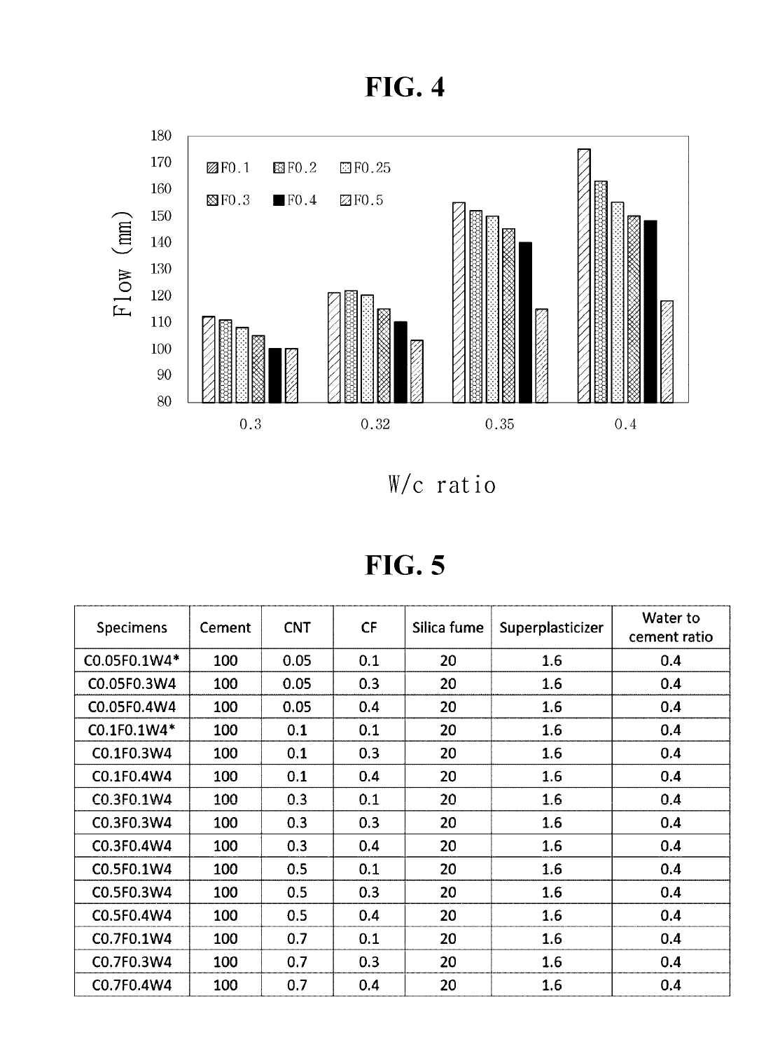

In addition, FIG. 4 shows a result of a flow test performed with a different water/cement ratio (w/c) such as 0.3, 0.32, 0.35 or 0.40 for a cement composite composition specimen prepared by changing the mixing amount of the carbon fibers to 0.1 wt %, 0.2 wt %, 0.25 wt %, 0.3 wt %, 0.4 wt % or 0.5 wt %.

Referring to the flow shown in FIG. 4, when the carbon fibers are mixed at 0.1 to 0.4 wt %, as the water/cement ratio (w/c) increases, the flow rapidly increases and workability is good. On the other hand, when the mixing amount of the carbon fibers is 0.5 wt %, since the flow is considerably low compared with other specimens, it can be seen that workability is poor. That is, when the carbon fibers are mixed at 0.5 wt %, the flow is ensured at a low level of about 118 mm even when the water/cement ratio (w/c) is increased up to 0.4, so that the workability is very poor in the preparation of the cement composite, and thus it is difficult to ensure the quality of the prepared cement composite.

Therefore, to ensure a uniform quality and obtain the cement composite having an electrical resistivity of 100 Ω·cm or less, the carbon fibers mixed in the cement composite composition of the present invention may be 0.1 to 0.4 with respect to the cement weight, and in consideration of economic feasibility, it is most preferable that the carbon fibers are included at 0.1 to 0.2 wt %.

In addition, FIG. 5 shows examples of specimens prepared by changing the mixing amount of the CNTs in a range of 0.05 to 0.7 wt % with respect to the cement weight, when the mixing amount of the carbon fibers mixed in cement is in a range of 0.1 to 0.4 wt %, and the water/cement ratio (w/c) was fixed at 0.4.

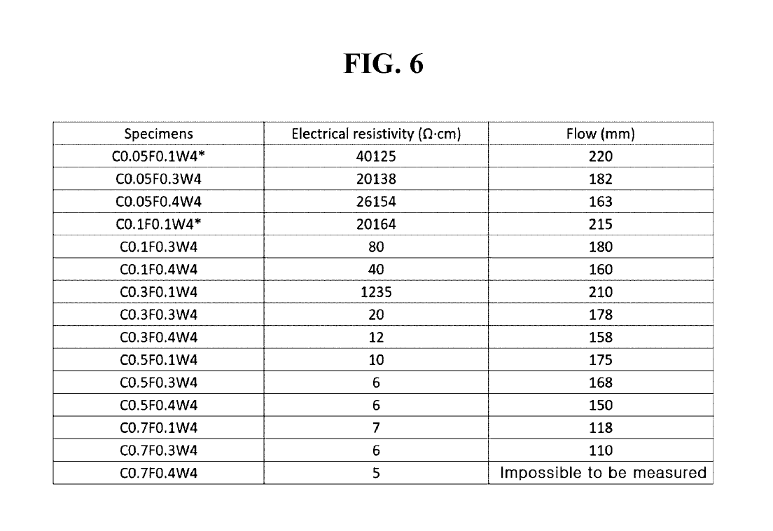

In addition, FIG. 6 is a set of graphs showing the changes in electrical resistivity and flow for the cement composite prepared through air dry curing after pouring each of the cement composite specimens shown in FIG. 5 into a cubic mold.

Referring to FIG. 6, when the mixing amount of the carbon nanotubes is 0.05 wt %, the electrical resistivity is as high as a level of 20,000 Ω·cm or more, and when the mixing amount of the carbon nanotubes is 0.7 wt %, the electrical resistivity is very low and conductivity is excellent. However, as the flow is considerably decreased to 118 or less, flowability is decreased. When the mixing amount of the carbon nanotubes is 0.1 to 0.5 wt %, both of the electrical resistivity and the flow were good, and thus it can be seen that excellent electrical performance and workability are exhibited.

Therefore, the mixing amount of the CNTs that can ensure both of electrical performance and workability is preferably limited to 0.1 to 0.5 wt % with respect to the cement weight.

As described above, the electrically conductive cement-based composite composition of the present invention may be prepared by mixing a nano material, CNTs, and a micro material, carbon fibers, as conductive fillers with a cement material, wherein the carbon fibers may be mixed at 0.1 to 0.4 wt % with respect to the cement amount, and when CNTs may be mixed at 0.1 to 0.5 wt % with respect to the cement weight, thereby simultaneously ensuring excellent electrical performance and excellent workability.

While the present invention has been described in detail with reference to the examples, it will be apparent to those of ordinary skill in the art that various substitutions, additions and modifications may be made without departing from the technical idea that has been described above, and it should be understood that the modified embodiments also belong to the scope of the present invention defined by the accompanying claims below.

The present invention relates to a cement material such as mortar or concrete, which can be applied to reduce a grounding resistance, prevent static electricity, and applied in a piezoresistive sensor, an electromagnetic wave-shielding material or a heating element product.

1. An electrically conductive cement-based composite composition, comprising:
cement, carbon nanotubes and 0.1 to 0.4 wt % of carbon fibers with respect to the cement weight.

2. The composition according to claim 1, wherein the carbon fibers are included at 0.1 to 0.2 wt % with respect to the cement weight.

3. The composition according to claim 1,
wherein the carbon nanotubes are included at 0.1 to 0.5 wt % with respect to the cement weight.

4. The composition according to claim 1, further comprising:
silica fume and a superplasticizer.

5. The composition according to claim 2, wherein the carbon nanotubes are included at 0.1 to 0.5 wt % with respect to the cement weight.

6. The composition according to claim 2, further comprising:
silica fume and a superplasticizer.
